(19) United States
(12) Patent Application Publication
(10) Pub. No.: US 2007/0298672 A1
(43) Pub. Date: Dec. 27, 2007

(54) Adhesive Composition for Sealing Electronic Component, and Process for Manufacturing Organic Electroluminescent Apparatus with Use Thereof

(75) Inventor: Takafumi Iida, Himeji-shi (JP)

Correspondence Address: EDWARDS ANGELL PALMER & DODGE LLP, P.O. BOX 55874, BOSTON, MA, 02205, US

(73) Assignee: Nagase Chemtex Corporation, Osaka (JP)

(21) Appl. No.: 11/587,729

(22) PCT Filed: May 6, 2005
(86) PCT No.: PCT/JP05/08345

§ 371 Date: Aug. 14, 2007

(30) Foreign Application Priority Data
May 7, 2004 (JP) 2004-138488

(51) Int. Cl. C09J 201/00; C09J 11/04; H01J 9/00; C09J 11/08

(52) U.S. Cl. 445/1; 522/74; 524/1; 524/442

(57) ABSTRACT

An adhesive composition for sealing containing spacer particles of diameter as large as 110 to 400 μm, which adhesive composition realizes manufacturing of an organic EL apparatus having a desiccant sheet disposed thereinside through a simple process with the use of a tabular sealing material; and a process for manufacturing an organic EL apparatus with the use of the adhesive composition. There is provided an adhesive composition for electronic component sealing comprising a resin of 1.1 to 1.3 specific gravity and, incorporated therein, spherical plastic spacers of 0.9 to 1.4 specific gravity and 110 to 400 μm particle diameter and having a viscosity of 200 to 1000 Pa s at 25° C. Further, there is provided a process for manufacturing an organic EL apparatus, comprising adhering a substrate with a tabular sealing material while ensuring a clearance of 110 to 400 μm therebetween with the use of the above adhesive composition.

### TECHNICAL FIELD

The present invention relates to an adhesive composition for sealing an electronic component, which contains a spacer having a large particle diameter and can accurately control the thickness of an adhesive layer, and particularly an adhesive composition containing a spherical plastic spacer having a large particle diameter, which is used for manufacturing an organic electroluminescent apparatus (also referred to as an organic EL apparatus), and to a process for manufacturing an organic electroluminescent apparatus with the use of the above-mentioned adhesive composition.

### BACKGROUND ART

A basic device structure of organic electroluminescence is such that an organic electroluminescent laminate having a sandwich construction in which a luminescent layer having a thickness of approximately several hundred nm or less, comprising a single-layer or multi-layer organic layer, is held between two electrodes is formed on a transparent substrate such as glass. However, the organic layer reacts with moisture to deteriorate and has a problem in durability; therefore, in an organic EL apparatus, the organic electroluminescent laminate is sealed in airtight space formed out of a substrate and a sealing material. An organic adhesive is typically used for this sealing and it is desirable that the substrate and the sealing material are airtightly adhered. However, in the case of adhering with the organic adhesive, it is so difficult to completely prevent permeation of moisture from the outside as to be incapable of sufficiently meeting a demand level at which the moisture content of an atmosphere surrounding an organic electroluminescent layer needs to be maintained at 1 ppm or less. Then, a desiccant is typically used. It is conceived that the use of a desiccant allows a durability of approximately, for example, 200 hours at 60° C. and 90%-RH atmosphere in the case of not using this to be performed up to a durability of 1000 to 2000 hours or more.

On the other hand, a desiccant sheet has a thickness of approximately 200 to 300 μm, and when this is placed in airtight space while placing a clearance from the organic electroluminescent laminate so as not to contact with the organic electroluminescent laminate, sealing space having a height of at least 200 to 300 μm needs to be secured. Thus, typically, a metal cap having space inside is used as the sealing material, or as shown in FIG. 2, a glass material in which a hollow for the adsorption-type drying agent layer is placed is used as the sealing material. However, the production of a cap-shaped sealing material and the placement of a hollow in a glass material causes a problem of increasing costs and deteriorating the flatness of the sealing material. Then, it is desirable that a tabular sealing material can be adhered to a substrate through a spacer. Examples of adhesive technology through a spacer include an adhesive for an electronic equipment component, such that particles are dispersed in an adhesive material (refer to Patent Literature 1), and a technique for sealing organic EL with an adhesive containing a spacer (refer to Patent Literatures 2 to 4). However, in these techniques, spherical particles and rod type particles having a comparatively small particle diameter are used, and though a spacer having a large particle diameter is described on the surface, the fact that the spacer having a large particle diameter is actually used is not disclosed, and in fact, only a columnar spacer having a comparatively small particle diameter is used. On the other hand, in the case of using the spacer having a large particle diameter, the inconvenience is such that separation of the spacer disables application by a dispensing process or a printing process, or the spacer is nonuniformly distributed in an adhesive layer. Therefore, an adhesive composition for sealing, which can practically be used for manufacturing an organic EL apparatus and the like by dispersing spacer particles having a large particle diameter in adhesive resin, has not been known yet.

Patent Literature 1: Japanese Unexamined Patent Publication No. 2002-20722

Patent Literature 2: Japanese Unexamined Patent Publication No. 2000-36384

Patent Literature 3: Japanese Unexamined Patent Publication No. 10-233283

Patent Literature 4: Japanese Unexamined Patent Publication No. 11-45778

### DISCLOSURE OF THE INVENTION

### Problems to be Solved by the Invention

In view of the above-mentioned present situation, the present invention is intended to provide an adhesive composition for sealing containing spacer particles having as large a particle diameter as 110 to 400 μm, which can manufacture an organic EL apparatus having a desiccant sheet disposed thereinside through a simple step by using a tabular sealing material, and can practically be used for manufacturing an organic EL apparatus while enabling simplification of manufacturing steps and reduction of manufacturing costs, and to provide a process for manufacturing an organic EL apparatus with the use of the adhesive composition.

### Means for Solving the Problem

Through earnest studies for solving the above-mentioned problem, the inventors of the present invention have completed the present invention by finding out that a spacer having a large particle diameter can uniformly be dispersed and the application thereof to adherend allows uniform spacer disposition when the specific gravity of a spacer having a large particle diameter is determined in a predetermined range and the viscosity is determined in a certain range.

That is to say, the present invention is an adhesive composition for sealing an electronic component (hereinafter referred to also as a composition of the present invention), which comprises a resin having a specific gravity of 1.1 to 1.3 and, incorporated therein, a spherical plastic spacer having a specific gravity of 0.9 to 1.4 and a particle diameter of 110 to 400 μm and having a viscosity of 200 to 1000 Pa·s at 25° C.

The present invention of the other embodiment is a process for manufacturing an organic electroluminescent apparatus by sealing an organic electroluminescent laminate formed on a transparent substrate together with a desiccant sheet placed on a tabular sealing material by the above-mentioned tabular sealing material, comprising (a) a step of applying an adhesive composition of the present invention to the above-mentioned substrate and/or the above-mentioned sealing material by a dispensing process or a printing process, and (b) a step of adhering the above-mentioned substrate to the above-mentioned sealing material by the above-mentioned adhesive composition with a separation of 110 to 400 μm therebetween in order to seal the above-mentioned substrate and the above-mentioned sealing material disposed oppositely with such a clearance that the above-mentioned organic electroluminescent laminate does not contact with the above-mentioned adsorption-type drying agent layer.

### EFFECTS OF THE INVENTION

With regard to the present invention, the above-mentioned constitution causes no inconvenience such that, even though a spacer having a large particle diameter is included, separation of the spacer disables application by a dispensing process or a printing process, or the spacer is nonuniformly distributed in an adhesive layer, so that an adhesive layer in which a clearance between adherends is accurately secured can be formed.

With regard to the present invention, the above-mentioned constitution allows a transparent substrate on which an organic electroluminescent laminate is formed to be oppositely sealed by a tabular glass sealing material on which a desiccant sheet is formed with such a clearance that the above-mentioned organic electroluminescent laminate does not contact with the above-mentioned adsorption-type drying agent layer.

With regard to the present invention, the above-mentioned constitution allows the substrate to be easily adhered to the sealing material with a separation of 110 to 400 μm therebetween by a dispensing processor a printing process. The constitution also allows a large interval of 110 to 400 μm to be accurately realized between various adherends in an easy manufacturing step.

### BRIEF DESCRIPTION OF THE DRAWINGS

FIG. 1 is a cross-sectional view of an organic EL apparatus having a desiccant sheet disposed thereinside, which is manufactured by a manufacturing process of the present invention.

FIG. 2 is a cross-sectional view of a conventional organic EL apparatus having a desiccant sheet disposed thereinside.

### EXPLANATION OF REFERENCE NUMERALS

1,1′. glass substrate
2,2′. anode
3,3′. organic layer
4,4′. drying agent layer
5,5′. adhesive layer
6,6′. spacer
7,7′. cathode
8,8′. glass sealing material
9. hollow
10,10′. clearance

### BEST MODE FOR CARRYING OUT THE INVENTION

A composition of the present invention is an adhesive composition which comprises a resin having a specific gravity of 1.1 to 1.3 and, incorporated therein, a spherical plastic spacer having a specific gravity of 0.9 to 1.4 and a particle diameter of 110 to 400 μm, and has a viscosity of 200 to 1000 Pa·s at 25° C. In the present invention, the viscosity is a value which can be obtained by measuring an adhesive composition in which the spacer is included at 25° C. with a viscometer, such as a rotational viscometer manufactured by Brookfield. A viscosity of less than 200 Pa·s causes the spacer to be separated in the composition during keeping and work, while a viscosity of more than 1000 Pa·s causes application to be uncontrolled. The viscosity is preferably 300 to 1000 Pa·s, more preferably 400 to 800 Pa·s.

The above-mentioned specific gravity is a value at 25° C. In the present invention, the specific gravity of a spacer is 0.9 to 1.4 while the specific gravity of resin is 1.1 to 1.3. The specific gravity out of this range in a spacer causes the spacer to be separated while storing an adhesive composition, so that uniform spacer distribution can not be secured in a coated adhesive layer and a gap between adherends can not precisely be controlled. On the occasion of applying, for example, during manufacturing steps of one day of operation, the problem is caused such that the spacer is sedimented or surfaced in a dispenser to cause clogging. The specific gravity of a spacer is preferably 1.0 to 1.3, more preferably 1.1 to 1.3 with respect to a specific gravity of 1.1 to 1.3 for resin. With regard to a combination of the specific gravity of resin and the specific gravity of a spacer, the specific gravity of a spacer is preferably in a range of ±0.2, more preferably in a range of ±0.1 with respect to the specific gravity of resin. In the case of higher viscosity of an adhesive composition, separation is difficult to occur even at large difference in specific gravity, while lower viscosity thereof brings a tendency of separation in the case of large difference in specific gravity; therefore, it is desirable that specific gravity difference is decreased when the viscosity of an adhesive composition is close to the lower limit of the above-mentioned range.

In a composition of the present invention, resin is not particularly limited if typically used for an adhesive composition as far as the specific gravity thereof is in the above-mentioned range, being preferably room-temperature curing resin, or ultraviolet or electron-beam curing resin. The specific gravity of such resin is typically in a range of 1.1 to 1.3.

Examples of the above-mentioned room-temperature curing resin include adhesive resin comprising epoxy resin, adhesive resin comprising polyurethane resin, adhesive resin comprising acrylic resin and adhesive resin comprising oxetane compound.

The above-mentioned room-temperature curing resin may contain curing agent and curing accelerator or curing catalyst. For example, the following are usable for room-temperature curing resin comprising epoxy resin: amine curing agent, and curing accelerators such as imidazole curing accelerator, amine adduct curing accelerator, phosphorous curing accelerator, organic metal complex and polyamine ureide (urea-denatured polyamine).

Examples of the above-mentioned ultraviolet or electron-beam curing resin include adhesive resin comprising epoxy resin, adhesive resin comprising acrylic resin, adhesive resin comprising a mixture of epoxy resin and acrylic resin, adhesive resin comprising oxetane compound, adhesive resin comprising a mixture of epoxy resin and oxetane compound, and adhesive resin comprising a mixture of acrylic resin and oxetane compound.

Examples of the above-mentioned epoxy resin include bisphenol A epoxy resin, hydrogenated bisphenol A epoxy resin, hydrogenated epoxy resin, bisphenol F epoxy resin, phenol novolac epoxy resin, ortho-cresol novolac epoxy resin, alicyclic epoxy resin, aliphatic epoxy resin, brominated bisphenol A epoxy resin, glycidyl ester epoxy resin and glycidyl ether epoxy resin.

Examples of photoinitator used for ultraviolet curing of epoxy resin include aromatic diazonium salt, aromatic iodonium salt, aromatic sulfonium salt, metallocene compound and silicon compound/aluminum complex.

In the present invention, the above-mentioned spherical plastic spacer has a particle diameter of 110 to 400 μm. A particle diameter of less than 110 μm prevents a desiccant sheet from being placed in sealing space in consideration of the thickness of practicable adsorption-type drying agent layer. A spacer having a particle diameter of more than 400 μm is unnecessary for placing a desiccant sheet in sealing space in consideration of the thickness of practicable adsorption-type drying agent layer, and it is difficult to acquire spherical plastic spacers having an even particle diameter. The above-mentioned particle diameter is the largest particle diameter in a particle group in the case where particle diameter distribution exists in a spacer particle group to be used for the reason that the largest particle diameter of a spacer particle group prescribes a gap size actually. In order to be used as a plastic spacer, plastic particles need to be rigid and not to be easily subject to compressive deformation. In addition, a shape thereof is preferably spherical, particularly, of higher sphericity for the reason that a shape such as columnar causes gaps to vary with a state of arrangement of spacers, which gaps can not be controlled to a certain gap. Examples of such a spherical plastic spacer having a large particle diameter that can be used include commercial products such as Micropearl (trade name, manufactured by Sekisui Fine Chemical Co., Ltd.) and Hayabeads (trade name, manufactured by Hayakawa Rubber Co., Ltd.).

The adding quantity of the above-mentioned spherical plastic spacer in a composition of the present invention is preferably 0.1 to 10 parts by weight, more preferably 0.2 to 5 parts by weight with respect to 100 parts by weight of resin. A quantity out of the above-mentioned range brings a possibility that the viscosity of the composition becomes too high.

A composition of the present invention may contain at least one kind of inorganic filler selected from the group consisting of silicic acid-containing filler and aluminum-containing filler. Examples of the above-mentioned silicic acid-containing filler include crystalline silica, fused silica, magnesium silicate and talc. Examples of the above-mentioned aluminum-containing filler include alumina, aluminum nitride, aluminum hydroxide and aluminum borate. Examples thereof may be silicic acid and aluminum-containing filler such as aluminum silicate and mica. These may be used singly or in a combination of two kinds or more. These are preferably 0.1 to 20 μm, more preferably 0.5 to 10 μm in average particle diameter. The above-mentioned inorganic filler having smaller particle diameter is separated with more difficulty in the case of being dispersed in liquid resin.

The above-mentioned inorganic filler is preferably contained in a composition of the present invention by 15 to 80% by weight, more preferably 20 to 70% by weight. Appropriate added quantity varies with component and particle diameter of each of the inorganic fillers, and thereby is preferred to be properly determined in the above-mentioned range.

Other additives can be used for a composition of the present invention unless the object of the present invention is deteriorated. Examples of such additives include silane coupling agent, leveling agent, antifoaming agent and tackiness agent. In particular, the addition of silane coupling agent brings the effect of being capable of improving compatibility of liquid resin with inorganic filler and spacer. Examples of silane coupling agent include γ-glycidoxypropyltrimetoxysilane, γ-glycidoxypropyltrietoxysilane, β-(3,4-epoxycyclohexyl)ethyltrimethoxysilane, β-(3,4-epoxycyclohexyl)ethyltriethoxysilane, vinyltrimethoxysilane, vinyltriethoxysilane, mercaptosilane, sulfide silane, ureide silane and aminosilane.

A process for manufacturing a composition of the present invention is not particularly limited, and raw materials are preferred to mix uniformly. For example, epoxy resin, photoinitator, inorganic filler, coupling agent, spacer and other necessary components are added and mixed, then mixed while stirred under heating and reduced pressure and degassed and dehydrated in accordance with an ordinary method. Mixing while stirring is performed on the conditions of a temperature of 40 to 80° C. under a reduced pressure of 1 to 20 torr for 30 minutes to 2 hours.

A composition of the present invention is used for sealing an electronic component. The above-mentioned electronic component can widely include such one that requires sealing with an accurate realization of an adhesive layer of 110 to 400 μm and can be applied to manufacture of an organic EL apparatus, a light receiving element and a light emitting element.

In manufacture of an organic EL apparatus, an organic electroluminescent element having a desiccant sheet disposed inside sealing space can be manufactured by a sealing material such as a tabular glass material with the use of the above-mentioned adhesive composition. This step is a process for manufacturing an organic electroluminescent apparatus by sealing an organic electroluminescent laminate formed on a transparent substrate such as glass together with a desiccant sheet placed on a tabular sealing material by the above-mentioned tabular sealing material, comprising at least (a) a step of applying a composition of the present invention to the above-mentioned substrate and/or the above-mentioned sealing material by a dispensing process or a printing process, and (b) a step of adhering the above-mentioned substrate to the above-mentioned sealing material by the above-mentioned adhesive composition with a separation of 110 to 400 μm therebetween in order to seal the above-mentioned substrate and the above-mentioned sealing material disposed oppositely with such a clearance that the above-mentioned organic electroluminescent laminate does not contact with the above-mentioned adsorption-type drying agent layer.

In manufacture of an organic EL apparatus, a step of placing a desiccant sheet on a tabular sealing material exists typically in addition to the above-mentioned steps (a) and (b). This step is typically performed before the above-mentioned step (a) and is not limited thereto, needless to say. This step can be performed simultaneously with, or after the step (a) and before the above-mentioned step (b), for example. A step of forming an organic electroluminescent laminate on a transparent substrate such as glass also exists and is typically performed before the above-mentioned step (a); generally, a transparent electrode, an organic luminescent layer and the other electrode are first formed in turn on a glass substrate by film forming apparatus. In the above-mentioned step (a), an adhesive composition is applied to a predetermined place of the above-mentioned substrate and/or the above-mentioned sealing material, typically the above-mentioned sealing material, by a dispenser and the like so that coating thickness becomes larger than a particle diameter of a spacer by approximately 50 to 250 μm. In the above-mentioned step (b), for example, it is preferred that the above-mentioned substrate and the above-mentioned sealing material are both pressed against each other up to spacer thickness for provisional fixation, and retained until room-temperature curing resin is cured, or cured ultraviolet or electron-beam curing resin by irradiating ultraviolet rays or electron rays.

Examples of the above-mentioned adsorption-type drying agent layer include a liquid type and a sheet-like type, either of which will do. The above-mentioned liquid drying agent is applied in a liquid state and thereafter sintered at a temperature of approximately 220° C. to obtain a drying agent layer. A sheet-like type is preferable in view of adsorption-type drying agent performance and flatness. It is desirable that the thickness thereof is in a range of 110 to 400 μm. The thickness of an organic electroluminescent laminate is typically as extremely thin as approximately 1500 to 5000 Å, so that a thickness of a drying agent layer in the above-mentioned range allows the drying agent layer to avoid contacting with the organic electroluminescent laminate.

Examples of the above-mentioned adsorption-type drying agent include barium oxide, potassium oxide, calcium oxide, sodium oxide, calcium chloride, magnesium oxide, sodium sulfate and calcium chloride.

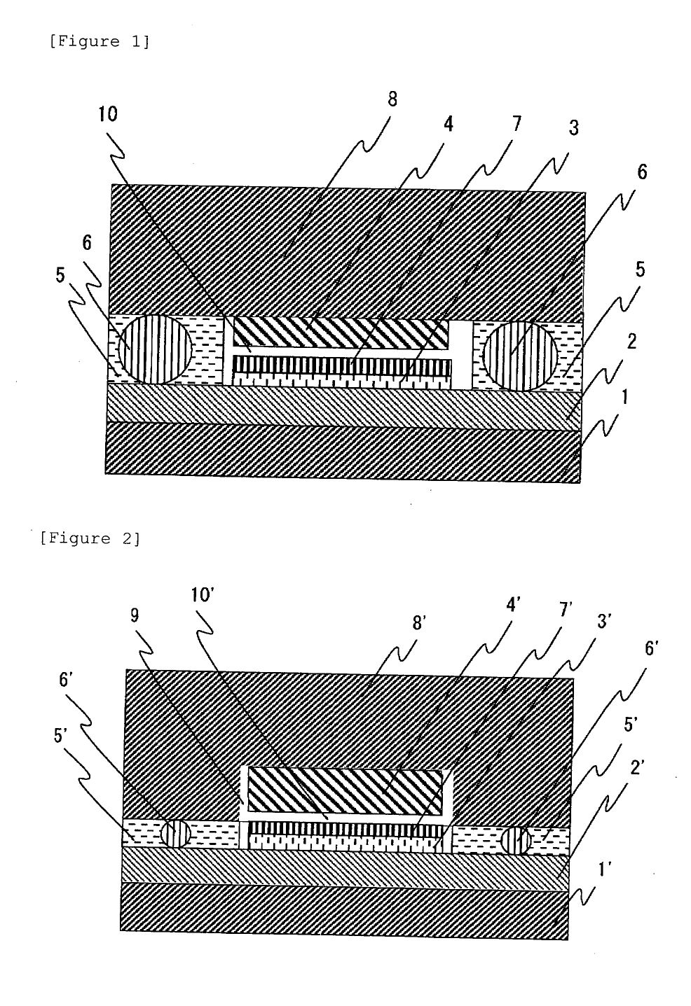

An embodiment of an organic EL apparatus manufactured by the above-mentioned manufacturing process is shown in FIG. 1. An organic electroluminescent laminate comprising an anode 2, an organic layer 3 and a cathode 7 are formed on a glass substrate 1. A desiccant sheet 4 is placed in the upper part of this organic electroluminescent laminate with a clearance 10 placed therebetween. A tabular glass sealing material 8 is adhered thereto through a spacer 6 by an adhesive layer 5.

On the other hand, a cross-sectional view of a conventional organic EL apparatus having a desiccant sheet disposed thereinside is shown in FIG. 2 for contrast. A spacer 6′ is small in particle diameter, so that a substrate 1′ can not be adhered to a sealing material 8′ with a sufficient separation therebetween. Thus, in order to place a desiccant sheet 4′ with such a clearance 10′ as not to contact with an organic electroluminescent laminate, a hollow 9 is placed in the sealing material 8′ to place the adsorption-type drying agent layer 4′ thereinside.

The present invention is further detailed by hereinafter referring to examples, and is not limited thereto.

### EXAMPLES 1 TO 5 AND COMPARATIVE EXAMPLES 1 TO 3

Each component was mixed in accordance with formulation of Table 1 to prepare an adhesive by an ordinary method. Abbreviations of the components in the Table are as follows.

Epoxy resin (A): AER250 (bisphenol epoxy resin) manufactured by Asahi Kasei Corporation

Epoxy resin (B): EPOLEAD PB3600 (epoxidized polybutadiene) manufactured by Daicel Chemical Industries, Ltd.

Epoxy resin (C): EPICLON153 (brominated bisphenol epoxy resin) manufactured by Dainippon Ink And Chemicals, Incorporated

Photoinitator: ADEKA OPTOMER SP170 manufactured by Adeka Corporation

Inorganic filler: spherical fused silica having an average particle diameter of 3 μm

Spacers (A) and (B): Micropearl (trade name) manufactured by Sekisui Fine Chemical Co., Ltd.

Spacer (C): Hayabeads (trade name) manufactured by Hayakawa Rubber Co., Ltd.

Spacer (D): FILLITE 52/7FG (trade name) (particle-size distribution of 5 to 300 μm) manufactured by Japan Fillite Co., Ltd.

Spacer (E): MICROROD PF-120 (trade name) manufactured by Nippon Electric Glass Co., Ltd.

Evaluation Method

Viscosity of an adhesive: the viscosity of a liquid adhesive controlled to a temperature of 25° C. was measured at a rotational speed of 10 rpm by a Brookfield rotational viscometer.

Specific gravity of an adhesive: the specific gravity of an adhesive in a liquid state was measured in distilled water controlled to a temperature of 25° C. by a water displacement method.

Separation of a spacer: 50 g of an adhesive was put (with a depth of approximately 100 mm) in a 50 cc-syringe vessel having a diameter of approximately 25 mm so as not to mix in air bubbles, which vessel was stood perpendicularly to take out the adhesive of 5 mm width in a depth direction on each of the top face and the bottom face of an adhesive layer in the vessel after being left for a predetermined time, which adhesive was applied on a glass plate, put between the plate and another glass plate, and pressed up to spacer thickness to count the number of spacers in 1 cm square by a microscope. With respect to the average of the number of spacers in the adhesive taken out of the top face and the number of spacers in the adhesive taken out of the bottom face, the case where the number of spacers in the adhesive taken out of the top face became 50% or less was evaluated as “sedimentation”, the case where the number became 150% or more was evaluated as “surfacing” and the case where the number was not 50% or less nor 150% or more was evaluated as “no separation”.

Adhesive after sticking together: when the thickness of the adhesive was measured after being cured, any thickness was a value equal to the size of a spacer. When the particle-size distribution of a spacer used in Comparative Example 1 was 5 to 300 μm, the average particle diameter was 150 μm and the largest particle diameter was 300 μm, the thickness of the adhesive was 300 μm.

TABLE 1

| | | Examples | | | | | Comparative Examples | | |
|---|---|---|---|---|---|---|---|---|---|
| | | 1 | 2 | 3 | 4 | 5 | 1 | 2 | 3 |
| Adhesive | Epoxy resin A | 100 | 100 | 50 | 80 | 100 | 100 | 80 | 100 |
| formulation | Epoxy resin B | — | — | 50 | — | — | — | — | — |
| | Epoxy resin C | — | — | — | 20 | — | — | 20 | — |
| | Photoinitator | 5 | 5 | 5 | 5 | 5 | 5 | 5 | 5 |
| | Inorganic | 70 | 30 | 40 | 20 | 160 | 40 | 20 | 10 |
| | filler | | | | | | | | |
| | Spacer A | 1 | — | — | — | — | — | — | 1 |
| | Spacer B | — | 1 | 1 | — | — | — | — | — |
| | Spacer C | — | — | — | 1 | 1 | — | — | — |
| | Spacer D | — | — | — | — | — | 1 | — | — |
| | Spacer E | — | — | — | — | — | — | 1 | — |

| | | | | | | | | |
|---|---|---|---|---|---|---|---|---|
| Spacer particle | 200 | 400 | 400 | 110 | 110 | Max 300 | 12 | 200 |
| diameter μm | | | | | | | | |
| Spacer specific | 1.2 | 1.3 | 1.3 | 1.2 | 1.3 | 0.7 | 2.6 | 1.2 |
| gravity | | | | | | | | |
| Adhesive viscosity | 500 | 200 | 600 | 300 | 800 | 300 | 300 | 100 |
| Pa · s | | | | | | | | |
| Resin specific gravity | 1.2 | 1.2 | 1.1 | 1.3 | 1.1 | 1.2 | 1.3 | 1.3 |
| Separation of 25° C./one | No | No | No | No | No | Surfacing | Sedimentation | Surfacing |
| day later | separation | separation | separation | separation | separation | | | |

According to the above-mentioned Examples, no separation of a spacer was caused even one day later in a composition of the present invention. This signifies that a spacer is uniformly distributed in an adhesive layer throughout manufacturing steps when applied by a dispenser and the like in a manufacturing site. Thus, a gap size can accurately be controlled to a predetermined value. A gap size can be determined in a range of 110 to 400 μm, so that an organic EL apparatus having a desiccant sheet disposed thereinside can be manufactured through a simple step by using a tabular sealing material. Thus, even though an adhesive layer can not completely hinder invasion of moisture from the outside, a function of the drying agent allows the moisture amount in sealing space to be maintained at a low level of requirement. Any of the adhesives of Comparative Examples did not have a constitution of the present invention, and separation of a spacer was caused therein.

### INDUSTRIAL APPLICABILITY

With regard to the present invention, the using of a spacer having a large particle diameter allows an organic EL apparatus having a desiccant sheet disposed thereinside to be manufactured through a simple step by using a tabular sealing material, and allows an organic EL apparatus having excellent durability to be manufactured while enabling simplification of manufacturing steps and reduction of manufacturing costs. An adhesive of the present invention is extremely appropriate for manufacturing optical devices such as a light receiving element and a light emitting element, in which focal length needs to be accurately controlled in manufacturing.

1. An adhesive composition for sealing an electronic component comprising a resin having a specific gravity of 1.1 to 1.3 and, incorporated therein, a spherical plastic spacer having a specific gravity of 0.9 to 1.4 and a particle diameter of 110 to 400 μm, and having a viscosity of 200 to 1000 Pa·s at 25 C.

2. The adhesive composition for sealing an electronic component according to claim 1, wherein said resin is room-temperature curing resin.

3. The adhesive composition for sealing an electronic component according to claim 1, wherein said resin is ultraviolet or electron-beam curing resin.

4. The adhesive composition for sealing an electronic component according to claim 1, further comprising at least one kind of inorganic filler selected from the group consisting of silicic acid-containing filler and aluminum-containing filler by 15 to 80% by weight of the composition.

5. A process for manufacturing an organic electroluminescent apparatus by sealing an organic electroluminescent laminate formed on a transparent substrate together with a desiccant sheet placed on a tabular sealing material by said tabular sealing material; comprising (a) a step of applying an adhesive composition for sealing an electronic component according to claim 1 to said substrate and/or said sealing material by a dispensing process or a printing process, and (b) a step of adhering said substrate to said sealing material by said adhesive composition with a separation of 110 to 400 m therebetween in order to seal said substrate and said sealing material disposed oppositely with such a clearance that said organic electroluminescent laminate does not contact with said adsorption-type drying agent layer.
